(19) United States
(12) Patent Application Publication
(10) Pub. No.: US 2014/0198016 A1
(43) Pub. Date: Jul. 17, 2014

(54) LOW-POWER MODE FOR DISPLAY

(71) Applicant: SONY MOBILE COMMUNICATIONS AB, Lund (SE)

(72) Inventors: Alexander Hunt, Lund (SE); Martin Ek, Lund (SE)

(73) Assignee: SONY MOBILE COMMUNICATIONS AB, Lund (SE)

(21) Appl. No.: 13/741,531

(22) Filed: Jan. 15, 2013

(51) Int. Cl. G09G 5/00

(52) U.S. Cl. CPC G09G 5/00
USPC 345/5; 345/4

(57) ABSTRACT

The invention is directed to systems, methods and computer program products for a low-power mode (or low-transmission state) associated with a display. An exemplary system comprises: a first display positioned on top of a second display, the first display at least partially covering the second display; the second display; a processor configured to: determine whether the first display is in low-transmission state or a high-transmission state; in response to determining the first display is in a low-transmission state, enable display of an image on the first display. Additionally, the system also updates an image on the display based on determining a frequency of updating an image on the display in the low-transmission state, and based on determining an amount of data to be updated on the display in the low-transmission state.

### BACKGROUND

The usage of transmissive display (e.g., liquid crystal display (LCD) technology and light emitting diode (LED) technology such as active-matrix organic LED (AMOLED), or the like) in the handset market is extensive. Transmissive displays are unsuitable in outdoor environments because transmissive displays are too power hungry to offer always-on functions (e.g., a date and time indicator, a weather indicator, or the like) or other functions that can be performed at lower power levels (e.g., power levels less than a predetermined threshold level).

### BRIEF SUMMARY

Embodiments of the invention are directed to systems, methods and computer program products for a low-power mode (or low-transmission state) associated with a display. Battery-driven systems benefit from the low-power mode described herein. In some embodiments, a system is provided for enabling display of an image. The system comprises: a first display positioned on top of a second display, the first display at least partially covering the second display; the second display; a sensor configured to determine an ambient light level proximate to a surface associated with at least one of the first display or the second display; a processor configured to: determine whether the first display is in low-transmission state or a high-transmission state; in response to determining the first display is in a low-transmission state, enable display of an image on the first display.

In some embodiments, the first display comprises a diffuse display.

In some embodiments, the second display comprises an emissive display.

In some embodiments, the first display is substantially clear when the first display is in a high-transmission state, and wherein the image is not visible when the first display is in a high-transmission state.

In some embodiments, the image comprises at least one of a time or date indicator, a weather indicator, a calendar, a photo, a logo, an event indicator, a moving image, or text, and wherein the image comprises at least one of a two-dimensional or three-dimensional image.

In some embodiments, the image comprises at least one color.

In some embodiments, the image is substantially joint-free.

In some embodiments, at least one of the first display or the second display is flexible about at least one axis.

In some embodiments, the first display functions as an electronically controlled optical filter.

In some embodiments, the system comprises a mobile device.

In some embodiments, a method is provided for enabling display of an image on a first display. The method comprises: determining whether the first display is in low-transmission state or a high-transmission state; in response to determining the first display is in a low-transmission state, enable display of an image on the first display.

In some embodiments, a computer program product is provided for enabling display of an image on a first display. The computer program product comprises a non-transitory computer-readable medium comprising code causing a computer to: determine whether the first display is in low-transmission state or a high-transmission state; in response to determining the first display is in a low-transmission state, enable display of an image on the first display.

In some embodiments, a system is provided for updating display of an image. The system comprises: a display comprising at least one pixel, the pixel comprising at least one sub-pixel; a memory, the memory being associated with at least one memory bit; a processor; a display; a processor configured to: determine whether the system is in a high-power mode or a low-power mode; in response to determining the system is in a low-power mode, determine a frequency of updating an image on the display in the low-power mode, and determine an amount of data to be updated on the display in the low-power mode; update the image based on the determined frequency and the determined amount of data.

In some embodiments, the memory comprises read-access memory.

In some embodiments, the low-power is associated with an amount of power less than a predetermined power level.

In some embodiments, the display is monochromatic in the low-power mode.

In some embodiments, the at least one sub-pixel comprises at least one of a red sub-pixel, a green sub-pixel, a blue sub-pixel, or a white sub-pixel, and wherein the at least one memory bit is associated with the at least one sub-pixel.

In some embodiments, the amount of data to be updated on the display in the low-power mode is based on a number of memory bits associated with the at least one sub-pixel.

In some embodiments, a backlight associated with the system is not activated in the low-power mode.

In some embodiments, the display can be switched from a high-power mode to a low-power mode based on a trigger event.

In some embodiments, the memory is integrated into a display driver or a backplane associated with the system.

In some embodiments, the system comprises a mobile device.

In some embodiments, a method is provided for updating display of an image on a display associated with a system. The method comprises: determining whether a system is in a high-power mode or a low-power mode; in response to determining the system is in a low-power mode, determining a frequency of updating an image on the display in the low-power mode, and determining an amount of data to be updated on the display in the low-power mode; updating the image based on the determined frequency and the determined amount of data.

In some embodiments, a computer program product is provided for updating display of an image on a display associated with a system. The computer program product comprises a non-transitory computer-readable medium comprising code causing a computer to: determine whether the system is in a high-power mode or a low-power mode; in response to determining the system is in a low-power mode, determine a frequency of updating an image on the display in the low-power mode, and determine an amount of data to be updated on the display in the low-power mode; update the image based on the determined frequency and the determined amount of data.

### BRIEF DESCRIPTION OF THE DRAWINGS

Having thus described embodiments of the invention in general terms, reference will now be made to the accompanying drawings, where:

FIG. 1 is an exemplary mode of operation (e.g., off-state) associated with display, in accordance with embodiments of the present invention;

FIG. 2 is another exemplary mode of operation associated with a display (e.g., on-state), in accordance with embodiments of the present invention;

FIG. 3 is an exemplary portable mobile communication device, in accordance with embodiments of the present invention;

FIG. 4 is a diagram illustrating a rear view of exemplary external components of the portable mobile communication device depicted in FIG. 3, in accordance with embodiments of the present invention;

FIG. 5 is a diagram illustrating exemplary internal components of the portable mobile communication device depicted in FIG. 3, in accordance with embodiments of the present invention;

FIG. 6 is an exemplary process flow, in accordance with embodiments of the present invention;

FIG. 7 is another exemplary process flow, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

The present invention comprises a display assembly. The display assembly may be incorporated into any electronic device that requires a display (e.g., a portable mobile device such as a mobile phone, a tablet computing device, a notebook computing device, a television, a watch, or the like). The display assembly comprises a first display (e.g., a diffuse display such as a polymer network (PN) display) stacked on top of a second display to enable low-power visibility of information on the display assembly (e.g., in an outdoor environment where the ambient light level is greater than a predetermined threshold). The second display may or may not be touching the first display. Additionally, the first display may either entirely or partially cover the second display. The first display produces high transmission (e.g., equal to or greater than a predetermined transmission level) in a first state and low transmission (e.g., less than a predetermined transmission level) in one or more second states. The second display comprises a transmissive display (e.g., LCD, OLED, AMOLED, or the like). The display assembly that comprises the first and second displays may be referred to as a PN-LCD display. The display technology for the second display produces high contrast (e.g., equal to or greater than a predetermined contrast level), vivid colors (e.g., equal to greater than a predetermined number of colors), and high switching speed (e.g., equal to or greater than a predetermined witching speed) in environments where the ambient light level is less than a predetermined light level. The second display is generally unsuitable for environments where the ambient light level is equal to or greater than the predetermined light level. As used herein, a display assembly comprising one or more displays may be referred to as just a display. In some embodiments, the display assembly described herein is integrated into a device (e.g., a communication device such as a mobile phone or a computing tablet). In other embodiments, the display assembly is separate from, and communicates with, a device described herein. As used herein, a diffuse display is a display based on diffuse technology.

When the PN-LCD is a low transmission state (e.g., transmission level is less than a predetermined transmission level), the PN-LCD creates a contrast ratio (CR) between the black level of the PN-LCD and the milky state (e.g., substantially white/whitish state) that occurs when the PN-LCD is in the low transmission state. This milky white state enables display of information (e.g., on the PN-LCD or on a surface located under the PN-LCD). The information may comprise a time and/or date indicator, a weather indicator, a calendar (e.g., the user's next appointment based on information associated with the user's calendar), a photo or picture, a logo (e.g., the manufacturer of the mobile device, the cellular carrier, etc.), an event indicator (e.g., an indicator that displays a current, future, or past event) a moving image, or the like. As used herein, a moving image refers to an image that floats or moves on the PN-LCD. The contrast ratio increases when the ambient light level increases. The PN-LCD is very power-efficient (e.g., greater than a predetermined power-efficiency level) for the purpose of performing the function of displaying the information described herein. The advantage of using a PN-LCD is that the transmission loss in a high transmission state (e.g., transmission level is greater than or equal to a predetermined transmission level) is limited (e.g., 10-20%), and the PN-LCD enables a reflective mode in a low transmission state. The reflective mode may be used for performing various functions that can be performed at power levels less than a predetermined threshold. As used herein, any reference to a low-power mode or state is equivalent to a reflective mode or state and is equivalent to an off-state or off-mode. Additionally, a transmissive mode or state (or high-power mode or state) may be referred to as an on-state or on-mode. As used herein, a white/whitish state is provided as an example. The white/whitish state may have any color, and is not limited to a white/whitish color.

Today's communication devices include fixed images or logos (e.g., logos associated with manufacturers of those devices or cellular carriers). There is a need for communication device to include images that can be switched on and off and images that can change from one point in time to another. Embodiments of the present invention are also directed to a display assembly that enables display of images that can be switched on and off and images that can be changed by the user.

In some embodiments, the display assembly described herein (e.g., the PN-LCD) acts as an electronically-controlled optical filter that enables display of a switchable fixed image. The filter has a substantially frosted or diffuse (whitish) off-state and a substantially clear (transparent) on-state. The off-state corresponds to the low-transmission (or low-power) state described herein and the on-state corresponds to the high-transmission (or high-power) state described herein. The off-state enables changing the “look” of the device (e.g., the off-state enables display of the image). Therefore, in the off-state, the display assembly enables viewing of an image (e.g., the image visible on the display assembly) that is not visible during the on-state. The image is hidden during the on-state. The image may be at least one of a two-dimensional or three-dimensional image. Additionally, the image may or may not be limited to a single color. The image may be a single color (e.g., black, white, red, green, blue, etc.) or may include a combination of colors described herein. The image may be substantially joint-free (e.g., very few or no joints) and may appear to be floating in the air above the plane of the display assembly. Additionally or alternatively, the image may appear to be present on a substantially smooth surface with no visible joints in the image. As used herein, a joint-free image is an image that is substantially smooth and does not appear to comprise one or more segments. Additionally, the difference in contrast level between one or more colors visible on the display assembly in the off-state and one or more colors visible on the display assembly in the on-state is greater than a predetermined contrast level. In some embodiments, the image may be an always-on image (e.g., a clock) such that that the image is continuously changing during the off-state of the display assembly.

In some embodiments, the display assembly may be switched from the off-state to the on-state, or the on-state to the off-state, by the user who can select a switching option via a user interface of the device comprising the display assembly. In other embodiments, the display assembly may be automatically switched from the off-state to the on-state, or from the on-state to the off-state, based on ambient light conditions detected by the device (e.g., a sensor associated with the device) comprising the device assembly. If the ambient light level is equal to or greater than a predetermined level, the display assembly changes to the off-state. If the ambient light level is less than the predetermined level, the display assembly changes to the on-state. In still other embodiments, the display assembly may be automatically switched from the off-state to the on-state, and from the on-state to the off-state, based on the power level associated with a power source incorporated into the device. If the power source level is equal to or greater than a predetermined level, the display assembly changes to the on-state. If the power source level is less than the predetermined level, the display assembly changes to the off-state.

In some embodiments, the display assembly described herein is flexible (e.g., at least one of the first display or the second display described herein is flexible). The display assembly may enable bending over a horizontal, vertical, or diagonal axis associated with the display assembly. The display assembly may bend 360 degrees around the axis. Additionally or alternatively, the display assembly may enable bending over a non-straight (e.g., curved) axis associated with the display assembly. Additionally or alternatively, the display assembly may enable simultaneous bending over multiple axes. A PN-LCD described herein is suitable for a flexible display assembly because a PN-LCD is not sensitive to cell gap thickness. Even when the display assembly is flexible, the image in the off-state is substantially joint-free. As used herein, “joint-free” means there are no visible image segments in the image that appears during the off-state. Additionally or alternatively, “joint-free” means that there is no appreciable visual difference between the active area (comprising the image) and the non-active area (not comprising the image) during the off-state. The active area is the area associated with the first display (which covers the second display) described herein, and the non-active area is the area associated with the second display (not covered by the first display) described herein. Additionally or alternatively, “joint-free” means there is no appreciable visual difference in the on-state (or in the off-state) between a first display area (e.g., where the first display overlaps the second display) and a second display area (e.g., where the first display does not overlap the second display). The second display area may be flatter than the first display area because the first display overlaps the second display on the first display area. In some embodiments, the flexible (or bendable) display assembly comprises flexible or bendable conductors (e.g., manufactured with indium tin oxide ITO) and enables substantially joint-free visual appearance of the image in the off-state. In some embodiments, the flexible assembly does not comprise bendable conductors. In such embodiments, the bendable conductors can be confined only to the second display area (and not the first display area) or only to the first display area (and not the second display area). Such a construction will still enable substantially joint-free visual appearance of the image in the off-state.

Embodiments of the invention are also directed to enabling a low-power mode for a display (e.g., a display assembly described herein or any other display assembly). A display may either be a RAM-based or RAM-less display. As used herein, the abbreviation RAM refers to read access memory. In embodiments of the invention described herein, RAM refers to any type of memory. In a RAM-based display, data associated with an image to be displayed on the display is transmitted to a display driver (e.g., an integrated circuit) and then no more data is transmitted to the display driver until the image needs to be changed. In a RAM-less display, data is continuously transmitted to the display driver; otherwise the display will not display any images. Embodiments of the invention are directed to a partial RAM-based display to enable low-power usage of a display. The low-power mode can be used to put the device into “stand-by” but it can also be used to perform functions such as book-reading, email usage, Internet browsing, or the like on a device that includes such a display. Additionally or alternatively, in a low-power mode, the display may present an image, a screensaver, a clock, weather widget, or the like. Therefore, the low-power mode enable performs of functions that require an amount of power less than a predetermined threshold power level. In some embodiments, the low-power mode enables display of only one color, while in other embodiments, the low-power mode enables display of more than one color. The benefits of the display are significant power savings during the low-power mode, lower load on display driver during the low-power mode, display of images or widgets during the low-power mode, enabling a user to work in a “read-only” mode (e.g., for reading electronic books), or the like. Additionally, the low-power mode may be associated with a low bandwidth requirement (e.g., a bandwidth less than a predetermined bandwidth threshold level).

A display comprises one or more pixels. Each pixel comprises one or more sub-pixels (e.g., a red sub-pixel, a green sub-pixel, a blue sub-pixel, a white sub-pixel or the like). Red, green, and blue sub-pixels are present in RGB display technology. Red, green, blue, and white sub-pixels are present in RGBW display technology. The white sub-pixel does not have color filtering material and is present to enable backlight through. The memory associated with the display comprises one or more memory bits on one or more sub-pixels. Therefore, a memory bit (or one or more memory bits) may be associated with a single sub-pixel (e.g., a white sub-pixel) or one or more sub-pixels associated with a pixel. The memory can be integrated into the display driver or into backplane that is required to switch each pixel (or sub-pixel) on and off. An exemplary backplane is a Low Temperature Polycrystalline Silicon (LTPS) backplane. The memory (comprising the memory bit) can be placed into a cell associated with the backplane, thereby forming an in-cell memory pixel. The pixel comprising one or more sub-pixels may be integrated with the backplane or may be separate from the backplane.

In order to produce a reflective mode (e.g., a mode triggered when the amount of ambient light detected by a sensor associated with the display is equal to or greater than a predetermined threshold level), a controller associated with the display driver switches the pixel (or a sub-pixel) from a transmissive mode to a reflective mode. In order to produce a transmissive mode (e.g., a mode triggered when the amount of ambient light detected by a sensor associated with the display falls below a predetermined threshold level), a controller associated with the display driver switches the pixel (or a sub-pixel) from a reflective mode to a transmissive mode. Alternatively, the controller may switch the display from a transmissive mode to a reflective mode, or from a reflective mode back to a transmissive mode, based on a power level associated with a power source (e.g., a battery) associated with the device comprising the display. If the power source level is equal to or greater than a predetermined power level, the controller switches the display from a reflective mode to a transmissive mode. If the power source level is less than the predetermined power level, the controller switches the display from the transmissive mode to the reflective mode. Alternatively, a user may manually select an option to enter a transmissive or reflective mode. The reflective mode comprises the low-power mode described herein.

As an example, consider a display with one bit memory for each sub-pixel associated with a display with 24 bit color depth. Assume the display has a resolution of 1920×1080. When the display is in transmissive mode, 50 MB (1920×1080×24) of data per image is sent to the display driver a predetermined number of times per second (e.g., 60 times). 1920×1080 refers to the resolution of the display, and 24 refers to the number of memory bits (or color bits). Therefore, if 50 MB/image is sent to the display driver at a frequency of 60 Hz, the data transfer speed (or processing speed) is 3 GB/s. When entering the low-power mode, the display may become monochromatic (e.g., a sub-pixel associated with a single color is active). In the low-power mode, the data transfer speed is lowered by a predetermined amount (e.g., by 24 times) for each image because the transmissive mode was associated with 24 color bits while the low-power mode is associated with 1 color bit. For example, when the display is in the low-power mode, a predetermined number of images (e.g., one image) needs to be sent to the display driver every predetermined period of time (e.g., a minute). For example, when the image presented during the low-power mode is a clock, the clock is updated once per minute. Therefore, for example, 2.1 MB of data per image (1920×1080×1) is sent to the display driver once per minute. 1920×1080 refers to the resolution of the display, and 1 refers to the number of memory bits. Therefore, in the low-power mode, there is no need for baseband processing or for any processor to be active until a new image needs to be sent to the display driver.

In the low-power mode, since the pixel associated with the display is reflective, the backlight does not need to be turned on. Therefore, the low-power mode enables significant power saving while producing an always-on display mode. In the low-power mode, the display driver needs to update only 1 sub-pixel per pixel instead of 3 or 4 sub-pixels per pixels that are updated during the transmissive mode. Therefore, the low-power mode reduces the display's power consumption by two-thirds in a three sub-pixel display and reduces the display's power consumption by three-fourths in a four sub-pixel display.

The invention is not limited to any particular types of devices or electronic devices. As used herein, an electronic device may refer to any computing or non-computing electronic device that includes a display. Examples of electronic devices include televisions, laptop computers, smart screens, tablet computers or tablets, desktop computers, e-readers, scanners, portable media, mobile computing devices (e.g., mobile phones), image capturing devices (e.g., cameras), gaming devices, or other portable or non-portable computing or non-computing devices.

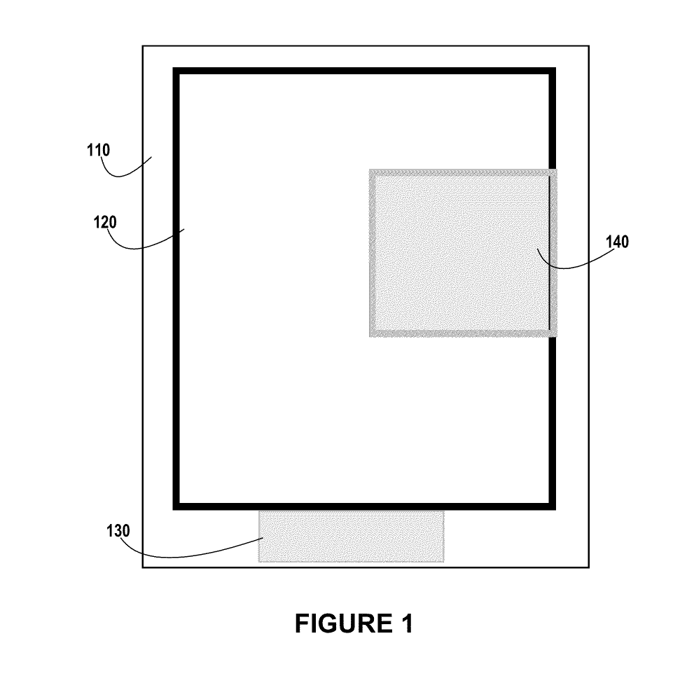

Referring now to FIG. 1, FIG. 1 presents an exemplary mode of operation (e.g., an off-mode) in accordance with some embodiments of the invention. FIG. 1 presents a mobile device 110. The mobile device comprises two instances of a first display 130 and 140 as described herein. The mobile device also comprises a second display 120 as described herein. The first display 140 covers the second display 120, while the first display 130 does not cover the second display 120. The first display 130 covers a non-display portion of the mobile device 110. In the off-mode (e.g., the low-transmission mode), the first displays 130 and 140 turn milky white (e.g., a diffuse or frosted state), and display at least one image (e.g., a time indicator, a logo, or the like) as described herein. Additionally, the off-mode enables execution of low-power functions as described herein. Information associated with the low-power functions may be presented on at least one of the first display or the second display (if the second display is not deactivated in the off-mode). In some embodiments, the image is monochromatic, while in other embodiments, the image comprises more than one color.

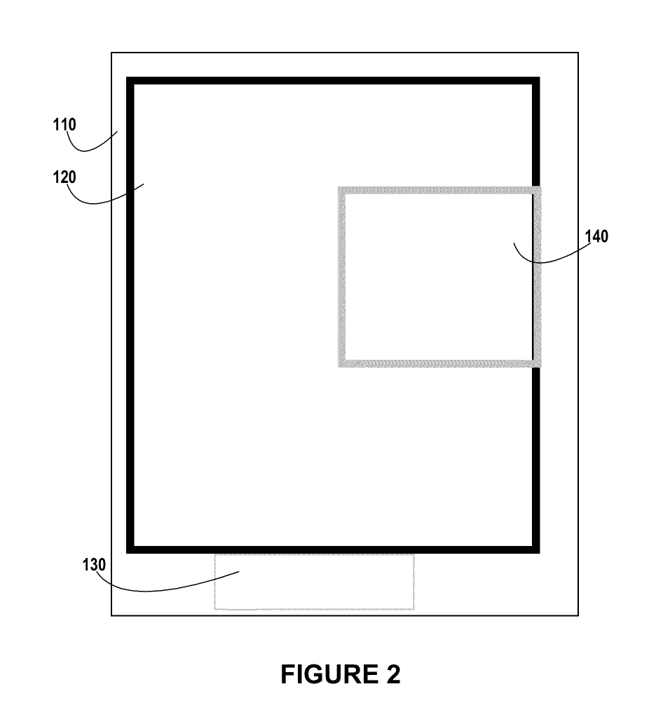

Referring now to FIG. 2, FIG. 2 presents another exemplary mode of operation (e.g., an on-mode) in accordance with some embodiments of the invention. FIG. 2 presents a mobile device 110. The mobile device comprises two instances of a first display 130 and 140 as described herein. The mobile device also comprises a second display 120 as described herein. The first display 140 covers the second display 120, while the first display 130 does not cover the second display 120. The first display 130 covers a non-display portion of the mobile device 110. In the on-mode (e.g., the high-transmission mode), the first displays 130 and 140 turn substantially clear. Therefore, in the on-mode, the second display 120 is visible through the first display 140, and the mobile device surface is visible through the first display 130. Additionally, the on-mode enables execution of high-power functions (e.g., functions that require more than a predetermined level of power) as described herein. In the on-mode, the second display 120 displays information. Although the borders of the first displays 130 and 140 is visible in FIG. 2, these borders are actually not visible to the naked eye in the on-mode. Therefore, the borders of the first displays 130 and 140 are shown for illustrative purposes only. Thus, when information is displayed on the second display, a user will not be able to view the presence of a first display 140 on top of the second display 120. The images that are visible in the first displays 130 and 140 during the off-state are not visible during the on-state.

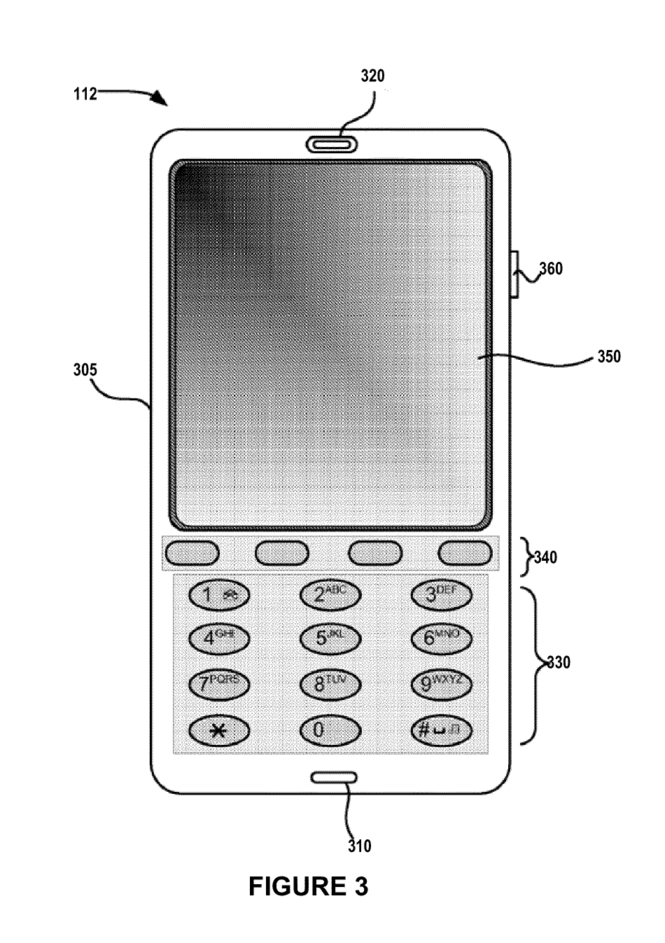

Referring now to FIG. 3, FIG. 3 is a diagram illustrating a front view of external components of an exemplary mobile device (e.g., a portable mobile communication device). As illustrated in FIG. 3, device 112 may include a housing 305, a microphone 310, a speaker 320, a keypad 330, function keys 340, a display 350, and a camera button 360. The display 350 may comprise at least one of the first display or the second display described herein. In some embodiments, the device 112 comprises a sensor to determine an ambient light level proximate the surface of the display 350.

Housing 305 may include a structure configured to contain or at least partially contain components of device 112. For example, housing 305 may be formed from plastic, metal or other natural or synthetic materials or combination(s) of materials and may be configured to support microphone 310, speaker 320, keypad 330, function keys 340, display 350, and camera button 360.

Microphone 310 may include any component capable of transducing air pressure waves to a corresponding electrical signal. For example, a user may speak into microphone 310 during a telephone call. Microphone 310 may be used to receive audio from the user or from the environment surround the device 112. Speaker 320 may include any component capable of transducing an electrical signal to a corresponding sound wave. For example, a user may listen to music through speaker 320.

Keypad 330 may include any component capable of providing input to device 112. Keypad 330 may include a standard telephone keypad. Keypad 330 may also include one or more special purpose keys. In one implementation, each key of keypad 330 may be, for example, a pushbutton. Keypad 330 may also include a touch screen. A user may utilize keypad 330 for entering information, such as text or a phone number, or activating a special function. In some embodiments, the keypad 330 may include virtual keys that are incorporated into a touch screen display 350. As used herein, a touch screen display may also be referred to as a touch panel display.

Function keys 340 may include any component capable of providing input to device 112. Function keys 340 may include a key that permits a user to cause device 112 to perform one or more operations. The functionality associated with a key of function keys 340 may change depending on the mode of device 112. For example, function keys 340 may perform a variety of operations, such as recording audio, placing a telephone call, playing various media, setting various camera features (e.g., focus, zoom, etc.) or accessing an application. Function keys 340 may include a key that provides a cursor function and a select function. In one implementation, each key of function keys 340 may be, for example, a pushbutton. In some embodiments, the function keys 340 are virtual keys that are incorporated into a touch screen display 350.

Display 350 may include any component capable of providing visual information. For example, in one implementation, display 350 may be a PN-LCD as described herein. In another implementation, display 350 may be any one of other display technologies, such as a plasma display panel (PDP), a field emission display (FED), a thin film transistor (TFT) display, etc. Display 350 may be utilized to display, for example, text, image, and/or video information. Display 350 may also operate as a view finder, as will be described later. Camera button 360 may be a pushbutton that enables a user to take an image.

Since device 112 illustrated in FIG. 3 is exemplary in nature, device 112 is intended to be broadly interpreted to include any type of electronic device that includes a display. For example, device 112 may include a wireless phone, a personal digital assistant (PDA), a portable computer, a camera, or a wrist watch. In other instances, device 112 may include, for example, security devices or military devices. Accordingly, although FIG. 3 illustrates exemplary external components of device 112, in other implementations, device 112 may contain fewer, different, or additional external components than the external components depicted in FIG. 3. Additionally, or alternatively, one or more external components of device 112 may include the capabilities of one or more other external components of device 112. For example, display 350 may be an input component (e.g., a touch screen). In some embodiments, the keypad 330 and the function keys 340 may be incorporated into the touch screen display 350. Therefore, the touch screen display 350 may substantially cover the entire front face of the device 112. Additionally, or alternatively, the external components may be arranged differently than the external components depicted in FIG. 3.

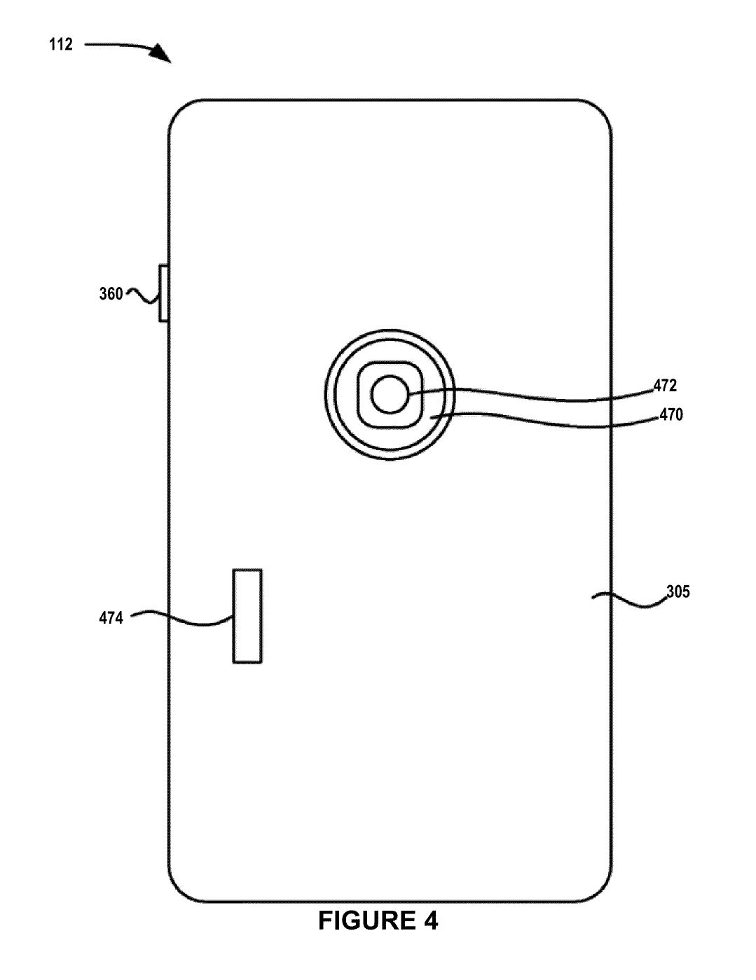

Referring now to FIG. 4, FIG. 4 is a diagram illustrating a rear view of external components of the exemplary device. As illustrated, in addition to the components previously described, device 112 may include a camera 470, a lens assembly 472, a proximity sensor 476, and a flash 474.

Camera 470 may include any component capable of capturing an image or a stream of images (video). Camera 470 may be a digital camera or a digital video camera. Display 350 may operate as a view finder when a user of device 112 operates camera 470. Camera 470 may provide for automatic and/or manual adjustment of a camera setting. In one implementation, device 112 may include camera software that is displayable on display 350 to allow a user to adjust a camera setting. For example, a user may be able adjust a camera setting by operating function keys 340.

Lens assembly 472 may include any component capable of manipulating light so that an image may be captured. Lens assembly 472 may include a number of optical lens elements. The optical lens elements may be of different shapes (e.g., convex, biconvex, plano-convex, concave, etc.) and different distances of separation. An optical lens element may be made from glass, plastic (e.g., acrylic), or plexiglass. The optical lens may be multicoated (e.g., an antireflection coating or an ultraviolet (UV) coating) to minimize unwanted effects, such as lens flare and inaccurate color. In one implementation, lens assembly 472 may be permanently fixed to camera 470. In other implementations, lens assembly 472 may be interchangeable with other lenses having different optical characteristics. Lens assembly 472 may provide for a variable aperture size (e.g., adjustable f-number).

Proximity sensor 476 may include any component capable of collecting and providing distance information that may be used to enable camera 470 to capture an image properly. For example, proximity sensor 476 may include an infrared (IR) proximity sensor that allows camera 470 to compute the distance to an object, such as a human face, based on, for example, reflected IR strength, modulated IR, or triangulation. In another implementation, proximity sensor 476 may include an acoustic proximity sensor. The acoustic proximity sensor may include a timing circuit to measure echo return of ultrasonic soundwaves. In embodiments that include a proximity sensor 476, the proximity sensor may be used to determine a distance to one or more moving objects, which may or may not be in focus, at least one of prior to, during, or after capturing of an image frame of a scene.

Flash 474 may include any type of light-emitting component to provide illumination when camera 470 captures an image. For example, flash 474 may be a light-emitting diode (LED) flash (e.g., white LED) or a xenon flash. In another implementation, flash 474 may include a flash module.

Although FIG. 4 illustrates exemplary external components, in other implementations, device 112 may include fewer, additional, and/or different components than the exemplary external components depicted in FIG. 4. For example, in other implementations, camera 470 may be a film camera. Additionally, or alternatively, depending on device 112, flash 474 may be a portable flashgun. Additionally, or alternatively, device 112 may be a single-lens reflex camera. In still other implementations, one or more external components of device 112 may be arranged differently.

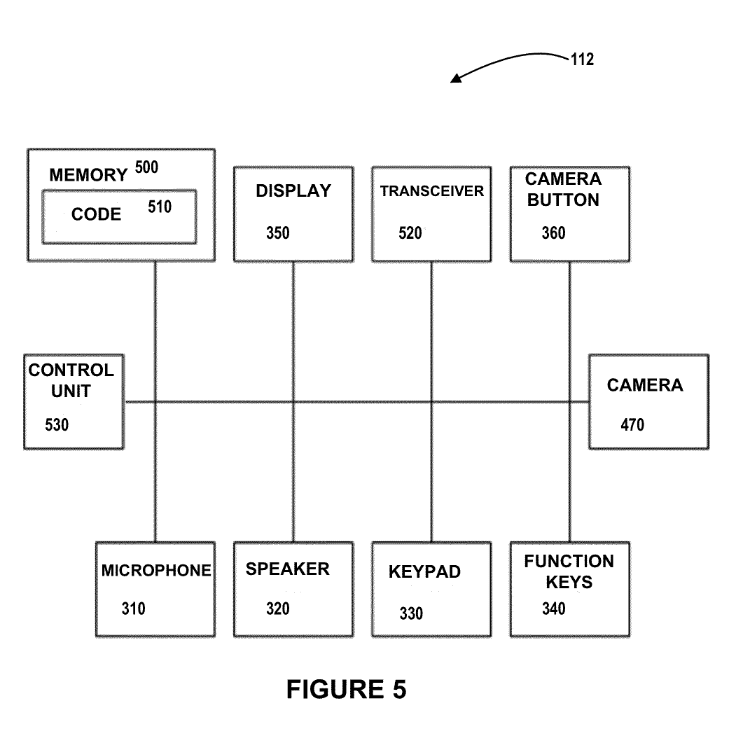

Referring now to FIG. 5, FIG. 5 is a diagram illustrating internal components of the exemplary portable mobile communication device. As illustrated, device 112 may include microphone 310, speaker 320, keypad 330, function keys 340, display 350, camera 470, camera button 360, memory 500, transceiver 520, and control unit 530. Although not illustrated in FIG. 5, device 112 may additionally include a lens assembly 472, a flash 474, and a proximity sensor 476.

Memory 500 may include any type of storing component to store data and instructions related to the operation and use of device 112. For example, memory 500 may include a memory component, such as a random access memory (RAM), a read only memory (ROM), and/or a programmable read only memory (PROM). Additionally, memory 500 may include a storage component, such as a magnetic storage component (e.g., a hard drive) or other type of computer-readable or computer-executable medium. Memory 500 may also include an external storing component, such as a Universal Serial Bus (USB) memory stick, a digital camera memory card, and/or a Subscriber Identity Module (SIM) card.

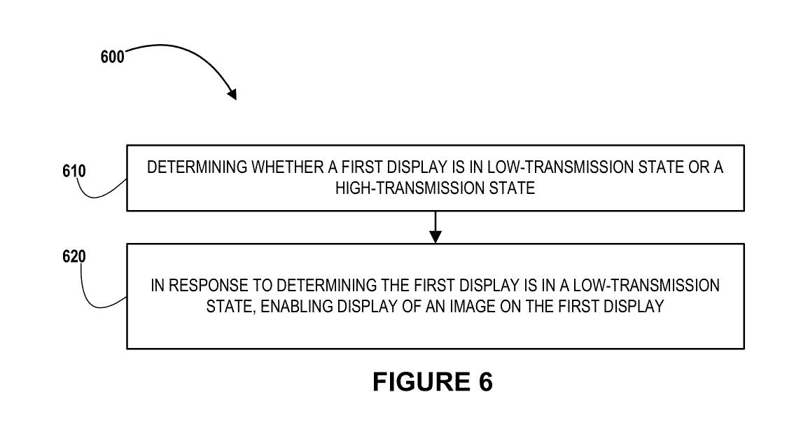

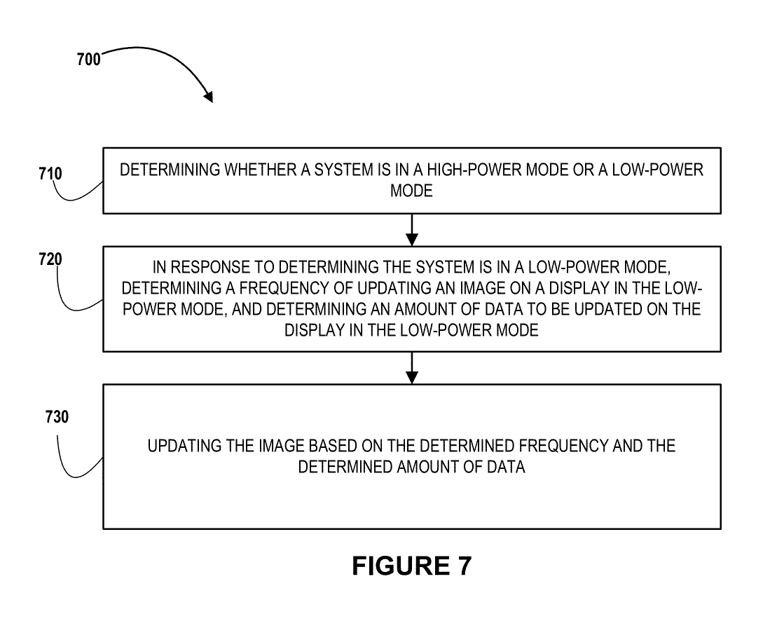

Memory 500 may include a code component 510 that includes computer-readable or computer-executable instructions to perform one or more functions. These functions include initiating and/or executing the processes described herein. The code component 510 may work in conjunction with one or more other hardware or software components associated with the device 112 to initiate and/or execute the processes illustrated in FIGS. 6 and 7 or other processes described herein. Additionally, code component 510 may include computer-readable or computer-executable instructions to provide other functionality other than as described herein.

Transceiver 520 may include any component capable of transmitting and receiving information wirelessly or via a wired connection. For example, transceiver 520 may include a radio circuit that provides wireless communication with a network or another device.

Control unit 530 may include any logic that may interpret and execute instructions, and may control the overall operation of device 112. Logic, as used herein, may include hardware, software, and/or a combination of hardware and software. Control unit 530 may include, for example, a general-purpose processor, a microprocessor, a data processor, a co-processor, and/or a network processor. Control unit 530 may access instructions from memory 500, from other components of device 112, and/or from a source external to device 112 (e.g., a network or another device).

Control unit 530 may provide for different operational modes (e.g., an on-mode, an off-mode, or the like) associated with device 112 (or the display associated with the device 112). Additionally, control unit 530 may operate in multiple modes simultaneously or switch between different modes. For example, control unit 530 may operate in a camera mode, a music player mode, and/or a telephone mode. For example, when in camera mode, logic may enable device 112 to capture video and/or audio.

Although FIG. 5 illustrates exemplary internal components, in other implementations, device 112 may include fewer, additional, and/or different components than the exemplary internal components depicted in FIG. 5. For example, in one implementation, device 112 may not include transceiver 520. In still other implementations, one or more internal components of device 112 may include the capabilities of one or more other components of device 112. For example, transceiver 520 and/or control unit 530 may include their own on-board memory.

Referring now to FIG. 6, FIG. 6 presents a process flow 600 for enabling display of an image. The various process blocks presented in FIG. 6 may be executed in an order that is different from that presented in FIG. 6. At block 610, the process flow comprises determining (e.g., controlling) whether a first display is in low-transmission state or a high-transmission state. At block 620, the process flow comprises in response to determining the first display is in a low-transmission state, enabling display of an image on the first display, wherein the first display has a whitish color when the first display is in a low-transmission state. As described herein, a first display is positioned on top of a second display and the first display at least partially covers the second display.

Referring now to FIG. 7, FIG. 7 presents a process flow 700 for updating display of an image on a display. The various process blocks presented in FIG. 7 may be executed in an order that is different from that presented in FIG. 7. At block 710, the process flow comprises determining whether a system associated with the display is in a high-power mode or a low-power mode. At block 720, the process flow comprises in response to determining the system is in a low-power mode, determining a frequency of updating an image on the display in the low-power mode, and determining an amount of data to be updated on the display in the low-power mode. At block 730, the process flow comprises updating the image based on the determined frequency and the determined amount of data.

In accordance with embodiments of the invention, the term “module” with respect to a system (or a device) may refer to a hardware component of the system, a software component of the system, or a component of the system that includes both hardware and software. As used herein, a module may include one or more modules, where each module may reside in separate pieces of hardware or software.

As used herein, the term “automatic” refers to a function, a process, a method, or any part thereof, which is executed by computer software upon occurrence of an event or a condition without intervention by a user.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for enabling display of an image, the system comprising:
a first display positioned on top of a second display, the first display at least partially covering the second display;
the second display;
a processor configured to:
determine whether the first display is in a low-transmission state or a high-transmission state; and
in response to determining the first display is in a low-transmission state, enable display of an image on the first display.

2. The system of claim 1, wherein the first display comprises a diffuse display.

3. The system of claim 1, wherein the second display comprises an emissive display.

4. The system of claim 1, wherein the first display is substantially clear when the first display is in a high-transmission state, and wherein the image is not visible when the first display is in the high-transmission state.

5. The system of claim 1, wherein the image comprises at least one of a time or date indicator, a weather indicator, a calendar, a photo, a logo, an event indicator, a moving image, or text.

6. The system of claim 1, wherein the image comprises at least one color.

7. The system of claim 1, wherein the image is substantially joint-free.

8. The system of claim 1, wherein at least one of the first display or the second display is flexible about at least one axis.

9. The system of claim 1, wherein the first display functions as an electronically controlled optical filter.

10. The system of claim 1, wherein the system comprises a mobile device.

11. A system for updating display of an image, the system comprising:
a display comprising at least one pixel, the pixel comprising at least one sub-pixel;
a memory, the memory being associated with at least one memory bit;
a processor configured to:
determine whether the system is in a high-power mode or a low-power mode;
in response to determining the system is in a low-power mode, determine a frequency of updating an image on the display in the low-power mode, and determine an amount of data to be updated on the display in the low-power mode; and
update the image based on the determined frequency and the determined amount of data.

12. The system of claim 11, wherein the memory comprises read-access memory.

13. The system of claim 11, wherein the low-power mode is associated with an amount of power less than a predetermined power level.

14. The system of claim 11, wherein the display is monochromatic in the low-power mode.

15. The system of claim 11, wherein the at least one sub-pixel comprises at least one of a red sub-pixel, a green sub-pixel, a blue sub-pixel, or a white sub-pixel, and wherein the at least one memory bit is associated with the at least one sub-pixel.

16. The system of claim 11, wherein the amount of data to be updated on the display in the low-power mode is based on a number of memory bits associated with the at least one sub-pixel.

17. The system of claim 11, wherein a backlight associated with the system is not activated in the low-power mode.

18. The system of claim 11, wherein the display can be switched from a high-power mode to a low-power mode based on a trigger event.

19. The system of claim 11, wherein the memory is integrated into a display driver or a backplane associated with the system.

20. The system of claim 11, wherein the system comprises a mobile device.
